(19) United States
(12) Patent Application Publication
(10) Pub. No.: US 2017/0203817 A1
(43) Pub. Date: Jul. 20, 2017

(54) GUNWALE MOUNTED OUTBROARD STORAGE DEVICE

(71) Applicant: ADAM DONLEY, LOCKPORT, IL (US)

(72) Inventor: ADAM DONLEY, LOCKPORT, IL (US)

(21) Appl. No.: 14/997,932

(22) Filed: Jan. 18, 2016

(51) Int. Cl. B63B 25/00; A01M 31/00; A01K 97/00; B63C 11/02

(52) U.S. Cl. CPC B63B 25/002; B63C 11/02; A01M 31/00; A01K 97/00

(57) ABSTRACT

The present invention relates to a height adjustable rack apparatus for Jon boats and the like, the apparatus including: a plurality of brackets attached to a boat gunwale, vertical supports extending from the base that are pivotally operable, and a pivotally adjustable rack apparatus supported by the vertical supports. There is no need for screws or clamps to attach the rack to the boat's gunwale. This apparatus is mainly used for duck hunting and fishing.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

This invention relates to devices for carrying and transporting objects on a Jon boat or a similar vehicle. More specifically, the invention relates to a carrier rack for use on a Jon boat or a similar vehicle for duck hunting.

(2) Background of the Invention

Usually, these inventions are targeted to specific storage support structures. An enormous problem that personal boats sold under the names of “Jet Ski”, “Wave Runner”, “Seadoo”, “AquTrax”, and others have always encountered is a lack of storage space. Boats generally only provide storage space in the bow and the glove box of the water craft.

Since personal boats are so small, they do not have large storage space for storing bulky items, such as fishing equipment, camping equipment, hunting equipment, water skies, wake boards, scuba diving equipment, inner-tubes, and other such articles or items.

People frequently carry cargo on boats. Specialized racks are available for securing recreational items inside or on the rear of boats. Carrying cargo outside of the boat is a convenient way to increase carrying capacity, particularly considering current trends to drive smaller, more efficient boats, and particularly with respect to inherently large items that usually don't fit well inside a boat, such as another boat, bikes, skis, and surf and paddle boards.

Some cargo items require straps to bind things to a rack or to the external surface of a boat. For example, straps are typically used to help position and/or secure boats. In some instances, a bracket is needed to secure the strap to the external surface of the boat, such as the rack. Such brackets may make it easy to load and transport cargo, such as a boat or canoe, on a rack. These types of brackets, when used to hold the gunwale of a boat or a canoe, may be referred to as gunwale brackets.

Heretofore, racks have been used for various purposes, such as net holders on trawlers, as in U.S. Pat. No. 3,805,722 to Melchert et al. A minnow box is shown in U.S. Pat. No. 2,721,718, to Wagner, which is mounted on the gunwales of a boat. In U.S. Pat. No. 5,165,645, to Brown, an exterior cooler holder is shown mounted on the rear of a vehicle.

U.S. Pat. No. 3,045,849 discloses an “up and over” system that uses pulleys, a pivoting arm that rises vertically from the center of the rack, and articulated support arms to connect the stern of the boat to the rear of the vehicle to both compound the leverage and to change the direction of force applied to the loading lines.

With the ability to engage in additional activities, there exists a substantial need in the art for an improved boat that can store the equipment necessary to engage in various activities. By utilizing a boat that is equipped with a multipurpose storage rack, the user can engage in any of a number of activities with the convenience of transporting the related gear with ease.

It, therefore, remains desirable to obtain some form of portable, removable racks that can be attached to a boat for the purpose of carrying bulky items, such as decoys and the like, that can be securely mounted to a boat yet will remain easily removable and that will carry gear or other equipment safely and in close proximity to the boat hull.

### SUMMARY OF THE INVENTION

The primary objective of the invention is to provide a luggage carrying structure adapted to be removably attached to the underside of a gunwale of a transporting vessel. The invention is a rack that is specifically structured for use on a boat to hold various equipment, including articles of gear, decoy bags, and the like, in a secured, easily accessible manner that does not clutter space or restrict movement about the boat.

In one intent the invention comprises of a a fixed frame adapted for mounting onto the transporting vessel for holding cargo onto it, wherein the fixed frame having a horizontal support surface, a vertical support surface and a bottom support surface, each the support surface formed by a plurality of tubular member having a first end and a second end, connectively spaced apart to form a surface and a means for removably securing the fixed frame onto the gunwale of the transporting vessel.

In one intent the present invention to increase the capacity of Jon boats to carry and store items, such as decoy bags, fishing equipment, hunting equipment, camping equipment, water skis, wake boards, scuba diving equipment, inner-tubes, and other articles or items. The invention to provide a Jon boat that has a multipurpose storage rack that provides a way to store items on the gunwale of the Jon boat. Further the storage rack that does not require screws nor clamps to be fixed to the gunwale, without mounting, and the rack simply hangs outside of the boat.

It is another intent the present invention utilize a Jon boat that has a multipurpose storage rack for storing items, such as decoy bags, fishing equipment, hunting equipment, camping equipment, water skies, wake boards, scuba diving equipment, and inner-tubes, as well as other articles or items, on the exterior of the boat.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows the prospective view of the side view of an aluminum multipurpose storage rack for a Jon boat.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

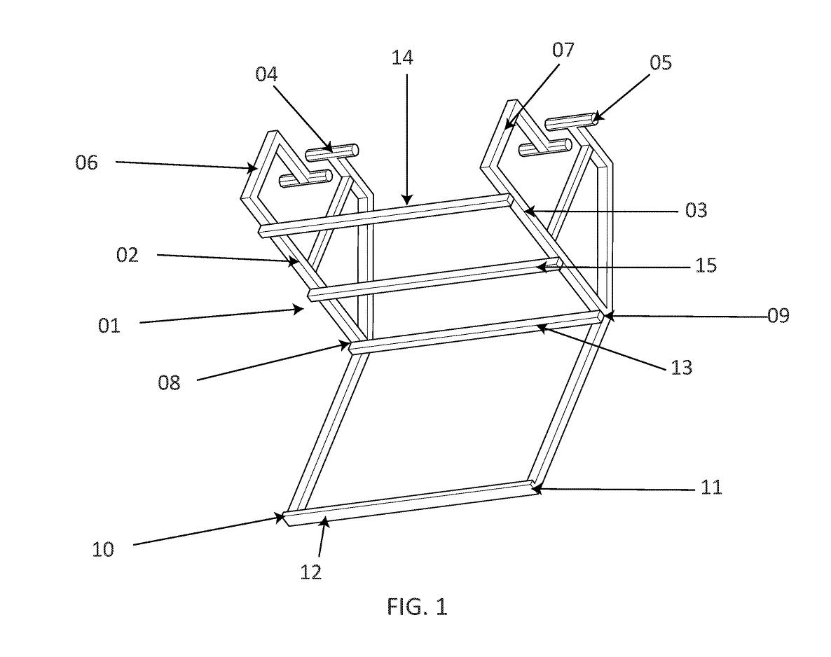

Referring now to the drawings, wherein like reference characters designate identical, or corresponding parts throughout the figures, and in particular FIGS. 1 show one embodiments of the luggage carrying structure in accordance with the present invention. In one embodiment the present invention comprise of a luggage carrying structure 01 comprising a fixed frame adapted for mounting onto the transporting vessel for holding cargo onto it, wherein the fixed frame having a horizontal support surface, a vertical support surface and a bottom support surface, each the support surface formed by a plurality of tubular member 02, 03 having a first end and a second end, connectively spaced apart to form a surface. Further the horizontal support surface further comprises of at least two connecting tubular member 14, 15 having two extremities placed on the plurality of tubular members 02, 03 forming the horizontal support surface. The vertical support surface further comprises of at least two connecting tubular members 12, 13 having two extremities 08, 09, 10, 11 each placed connecting the first end and the second end of the plurality of tubular member forming the vertical support surface. Moreover the second ends of the plurality of tubular member forming the vertical support surface are attached to the first ends of the plurality of tubular member forming the horizontal support surface forming a L-shaped structure.

In another embodiment the first ends of the plurality of tubular member forming the bottom support surface is pivotally attached to the first ends of the plurality of tubular members 02, 03 forming the horizontal support surface. The second end of the plurality of tubular members 06, 07 forming the bottom support surface is perpendicularly attached to a base member forming a T-shape. At least two connecting tubular member having two extremities is placed between adjacent tubular member forming the bottom support surface and the horizontal support surface.

In another embodiment the tubular members 06, 07 forming the bottom support surface is curved and has a stiffening dent. The stiffening dent is at a middle region of the tubular members forming the bottom support surface. Also the luggage carrying structure is externally attached to the transporting vessel.

In another embodiment, the means for removably securing the fixed frame onto the gunwale of the transporting vessel is a combination of at least two tubular components. The one tubular component having a stiffening dent suspends from the second ends of the plurality of tubular member forming the horizontal support surface. The one tubular components suspending from the horizontal support elevates from the stiffening dent. Also the tubular components 04,05 suspending from the horizontal support forms a shape of a hook.

The present invention provides boaters with a rack for carrying articles that would otherwise need to be left behind or crowded into the boat. The rack is supported on the outside of the boat. From the very beginning of boat design and construction, designers have devised innumerable ways of stowing and restraining on-board equipment and accessories. With the growing popularity of high-performance watercraft, the need to stow and restrain water-sports' accessories, such as boards and waterskis, has become particularly relevant. Specifically, designs of racks and storage compartments that do not interfere with the operation of the watercraft permit these boats to be used and enjoyed in conjunction with other watersports, such as hunting or fishing.

As disclosed herein, essential elements of the adjustable storage apparatus include, but are not limited to, a rack. This rack rigidly attaches to a Jon boat gunwale, wherein a pivotally adjustable rack apparatus is supported by the vertical supports. The adjustable rack apparatus hangs outside of the Jon boat for temporary attachment with the gunwale.

The use of a rack in the invention, no matter which embodiment is employed, provides a removable space on the outside of the boat. Generally, the type of boat that needs external storage space would be smaller open fishing boats of less than 24 feet in length. The rack of the invention removes some of the space problems.

In another embodiment the luggage carrying structure is made of metals, metallic alloy and combination thereof.

It is to be understood that the above description is intended to be illustrative, and not restrictive. For example, the above-discussed embodiments may be used in combination with each other. Many other embodiments will be apparent to those of skill in the art upon reviewing the above description.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A luggage carrying structure adapted to be removably attached to the underside of a gunwale of a transporting vessel, said structure comprising:
a fixed frame adapted for mounting onto said transporting vessel for holding cargo onto it, wherein said fixed frame having a horizontal support surface, a vertical support surface and a bottom support surface, each said support surface formed by a plurality of tubular member having a first end and a second end, connectively spaced apart to form a surface; and
a means for removably securing said fixed frame onto the said gunwale of said transporting vessel.

2. A luggage carrying structure adapted to be removably attached to the underside of a gunwale of a transporting vessel as set forth in claim 1, wherein said horizontal support surface further comprises of at least two connecting tubular members having two extremities placed on said plurality of tubular member forming said horizontal support surface.

3. A luggage carrying structure adapted to be removably attached to the underside of a gunwale of a transporting vessel as set forth in claim 1, wherein said vertical support surface further comprises of at least two connecting tubulars member having two extremities each connecting said first end and said second end of said plurality of tubular member forming said vertical support surface.

4. A luggage carrying structure adapted to be removably attached to the underside of a gunwale of a transporting vessel as set forth in claim 1, wherein said second ends of said plurality of tubular members forming said vertical support surface is attached to said first ends of said plurality of tubular member forming said horizontal support surface forming a L-shaped structure.

5. A luggage carrying structure adapted to be removably attached to the underside of a gunwale of a transporting vessel as set forth in claim 1, wherein said first ends of said plurality of tubular members forming said bottom support surface is pivotally attached to said first ends of said plurality of tubular members forming said horizontal support surface.

6. A luggage carrying structure adapted to be removably attached to the underside of a gunwale of a transporting vessel as set forth in claim 1, wherein said second ends of said plurality of tubular members forming said bottom support surface is perpendicularly attached to a base member forming a T-shape.

7. A luggage carrying structure adapted to be removably attached to the underside of a gunwale of a transporting vessel as set forth in claim 1, wherein said at least two connecting tubular members having two extremities is placed between adjacent tubular member forming said bottom support surface and said horizontal support surface.

8. A luggage carrying structure adapted to be removably attached to the underside of a gunwale of a transporting vessel as set forth in claim 1, wherein said tubular members forming said bottom support surface is curved and has a stiffening dent.

9. A luggage carrying structure adapted to be removably attached to the underside of a gunwale of a transporting vessel as set forth in claim 1, wherein said stiffening dent is at a middle region of said tubular members forming said bottom support surface.

10. A luggage carrying structure adapted to be removably attached to the underside of a gunwale of a transporting vessel as set forth in claim 1, wherein said luggage carrying structure is externally attached to said transporting vessel.

11. A luggage carrying structure adapted to be removably attached to the underside of a gunwale of a transporting vessel as set forth in claim 1, wherein said luggage carrying structure is made of metals, metallic alloy and combination thereof.

12. A luggage carrying structure adapted to be removably attached to the underside of a gunwale of a transporting vessel as set forth in claim 1, wherein said means for removably securing said fixed frame onto the said gunwale of said transporting vessel is a combination of at least two tubular components.

13. A luggage carrying structure adapted to be removably attached to the underside of a gunwale of a transporting vessel as set forth in claim 1, wherein said one tubular component having a stiffening dent suspends from said second ends of said plurality of tubular member forming said horizontal support surface.

14. A luggage carrying structure adapted to be removably attached to the underside of a gunwale of a transporting vessel as set forth in claim 1, wherein said one tubular components suspending from said horizontal support elevates from said stiffening dent.

15. A luggage carrying structure adapted to be removably attached to the underside of a gunwale of a transporting vessel as set forth in claim 1, wherein said tubular components suspending from said horizontal support forms a shape of a hook.
